(19) United States
(12) Patent Application Publication
(10) Pub. No.: US 2006/0129581 A1
(43) Pub. Date: Jun. 15, 2006

(54) Determining a level of expertise of a text using classification and application to information retrival

(75) Inventors: Simon J. Case, Saxmundham (GB); Michelle J Fisher, Exeter (GB)

Correspondence Address: NIXON & VANDERHYE, PC, 901 NORTH GLEBE ROAD, 11TH FLOOR, ARLINGTON, VA, 22203, US

(73) Assignee: BRITISH TELECOMMUNICATIONS PUBLIC LTD CO, London (GB)

(21) Appl. No.: 10/544,104

(22) PCT Filed: Jan. 20, 2004
(86) PCT No.: PCT/GB04/00143

§ 371 Date: Aug. 2, 2005

(30) Foreign Application Priority Data
Feb. 10, 2003 (GB) 0303018.6

(51) Int. Cl. G06F 17/00

(52) U.S. Cl. 707/101

(57) ABSTRACT

An apparatus and method are provided for determining a level of expertise applicable to a particular document and for using this determined level of expertise in an improved information retrieval arrangement. A trainable document classifier is used to identify an applicable level of expertise using a metric indicative of the commonality, as measured with reference to a reference corpus, of terms comprised in a given document, trained using a training set of documents comprising, for each of a plurality of predetermined levels of expertise, a representative sample of documents and their respective metric values. An information retrieval apparatus is arranged to identify documents relevant to a specified category of information and to select from documents so identified those having a level of expertise, determined by the trained document classifier, matching a specified level of expertise for a target user in respect of that category of information.

This invention relates to information retrieval and in particular to a method and apparatus for identifying and retrieving information taking account of a level of expertise likely to be required of a user accessing it, and to a particular method and apparatus for determining the level of expertise applicable to a given set of information.

It is known to classify documents according to a number of different criteria, in particular according to information topic. Numerous prior art techniques have been devised to achieve automatic or semi-automatic classification of documents. Known classification techniques have been applied in particular to information retrieval arrangements to group or to help locate documents relating to particular topics of interest. However, while a search for relevant documents may be successful in locating a number of documents relevant to a particular topic of interest, the intended audience for each document will vary and many located documents may prove unsuitable for particular users, being for example too general for a specialised user having significant expertise in the topic.

According to a first aspect of the present invention there is provided a method for determining a measure of the level of expertise applicable to an information data set, comprising the steps of:

(i) selecting, in respect of each of a plurality of predetermined levels of expertise, a representative sample set of information data sets;

(ii) determining, for each of said selected information data sets, the value of a metric indicative of the incidence, in a reference corpus of information, of terms comprised in the selected data set; and

(iii) using the values of said metric determined in step (ii) to train an information classifier to identify at least one of said plurality of predetermined levels of expertise applicable to an information data set using a value of said metric determined for the information data set.

The metric chosen for use in preferred embodiments of the present invention has the property that the values of the metric, calculated for different representative samples of data sets in a training set selected in step (i) above, fall within substantially distinct ranges. This enables a document classifier to be trained to rate a given information data set according to which of the predetermined levels of expertise is most applicable, based solely upon the value of the metric calculated for the information data set being rated.

A value for the metric is calculated with reference to a reference corpus of information in a relevant language. In preferred embodiments of the present invention, the reference corpus used is the British National Corpus, referenced below, although an equivalent corpus may be available in respect of languages other than English. The reference corpus provides a measure, for each term, of the incidence of that term in the language represented by the corpus. For the purposes of the present patent application, “term” is intended to relate to a word or phrase or part of a word, e.g. a stemmed word. Different more specialised corpi of information may be selected, for example a corpus representative of the use of terms in speech, a corpus representative of written use, or a corpus of children's literature in a particular language.

Preferably the metric comprises a combined measure of the incidence within an information data set of terms comprised in the information data set and of the incidence of each said term in the reference corpus. In this way, the observed incidence of a particular term in the reference corpus may be weighted more highly, and hence contribute more to the value of the metric, the more frequently that term is found to occur in the information data set being rated. A preferred formula for calculating values for the metric is given in the detailed description below.

Preferably, training the classifier comprises:

(a) making distributions of normalised values of said metric for data sets in each of the representative sample sets selected at step (i), above; and

(b) for each of said predetermined levels of expertise, identifying from said distributions a corresponding range of normalised values of said metric.

Normalised values of the metric are obtained, in a preferred embodiment of the present invention, by taking account of the length of the information data set being rated in comparison with the mean length of data sets used to construct the reference corpus.

In a preferred embodiment of the present invention, the trained classifier is arranged to determine a measure of the probability that a particular one of said predetermined levels of expertise is applicable to the information data set being rated. For example, if it is found that distributions of the calculated values of the metric for the training samples of data sets are overlapping to some degree, then there may be more than one level of expertise yielding a non-zero probability of association with information data set being rated. An output expressed in the form of probabilities for each predetermined level of expertise may be particularly useful in fuzzy processing arrangements.

Preferably, determining a value for said metric comprises applying a stemming algorithm to stem terms comprised in a respective information data set and determining the incidence of the stemmed terms in the reference corpus. In particular, a algorithm such as Porter, M. F., 1980, “An algorithm for suffix stripping”, Program, 14(3):130-137, since reprinted in Sparck Jones, Karen, and Peter Willet, 1997, Readings in Information Retreval, San Francisco: Morgan Kaufmann, ISBN 1-55860-454-4, may be used to stem terms prior to obtaining their measure of incidence in the reference corpus.

According to a second aspect of the present invention there is provided a method of accessing information data sets, stored in an information system, relevant to search criteria specifying an indication of a category of information to be accessed and an indication of a predetermined level of expertise in respect of said category of information, the method comprising the steps of:

(i) selecting a training set of information data sets comprising, for each of a predetermined plurality of levels of expertise, a representative sample set of information data sets;

(ii) determining, for each data set in the training set, the value of a metric indicative of the incidence, in a reference corpus of information, of terms comprised in the training data set;

(iii) using the values of said metric determined in step (ii) to train an information classifier to identify at least one of said predetermined plurality of levels of expertise applicable to a given information data set;

(iv) applying an information searching algorithm to identify information data sets stored in said information system relevant to said specified category of information; and

(v) using the classifier trained at step (iii) to determine respective levels of expertise for information data sets identified at step (iv) and comparing the determined levels of expertise with the level of expertise specified in said search criteria to thereby select relevant information data sets.

When searching for documents relevant to a particular category of information, by taking account also of the level of expertise of a user initiating the search in that information category and matching the user's level of expertise with that determined as being necessary for documents identified in the search, the search results selected for presentation to that user are likely to be more useful than those in a similar arrangement that otherwise ignores the intended level of expertise of readers of identified documents.

According to a third aspect of the present invention there is provided an apparatus for determining a level of expertise applicable to an information data set, the level of expertise being selected from a predetermined plurality of levels of expertise, the apparatus comprising:

an input for receiving an information data set;

calculating means arranged with access to a reference corpus of information to calculate, for an information data set, the value of a metric indicative of the incidence, in the reference corpus, of terms comprised in the information data set;

a trainable classifier; and

training means for training said classifier to identify, using a training set of information data sets comprising, for each of said predetermined plurality of levels of expertise, a representative sample set of information data sets and respective values of said metric, an applicable level of expertise selected from said predetermined plurality of levels of expertise for a received information data set;

wherein, in operation, on receipt of an information data set at said input, said calculating means are arranged to calculate a respective value for said metric and to input the calculated value to said trainable classifier, trained by said training means, to determine and output an indication of at least one of said predetermined plurality of levels of expertise applicable to said received information data set.

According to a fourth aspect of the present invention there is provided an information retrieval apparatus for accessing information data sets, stored in an information system, relevant to received search criteria specifying an indication of a category of information to be accessed and an indication of a predetermined level of expertise in respect of said category of information, the apparatus comprising:

calculating means arranged with access to a reference corpus of information to calculate, for an information data set, the value of a metric indicative of the incidence, in the reference corpus, of terms comprised in the information data set;

a trainable classifier;

training means for training said classifier to identify, using a training set of information data sets comprising, for each of a predetermined plurality of levels of expertise, a representative sample set of information data sets and respective values of said metric, an applicable level of expertise selected from said predetermined plurality of levels of expertise for a given information data set;

searching means for identifying information data sets in said information system relevant to said specified category of information to be accessed; and

selecting means arranged to trigger said calculating means to calculate values of said metric for information data sets identified by said searching means, to input the values so calculated to said trainable classifier, trained by said training means, to determine and output respective applicable levels of expertise selected from said predetermined plurality of levels of expertise, and to select, for access, information data sets from those identified by said searching means having respectively determined levels of expertise that match said specified level of expertise.

According to a fifth aspect of the present invention there is provided an information retrieval apparatus for accessing information data sets, stored in an information system, relevant to received search criteria specifying an indication of a category of information to be accessed and to a specified indication of a predetermined level of expertise in respect of said category of information, the apparatus comprising:

calculating means arranged with access to a reference corpus of information to calculate, for an information data set, the value of a metric indicative of the incidence, in the reference corpus, of terms comprised in the information data set;

an information classifier, trained, using, for each of a plurality of predetermined levels of expertise, a representative sample set of training information data sets and respective values of said metric, to determine a level of expertise, selected from said plurality of predetermined levels of expertise, applicable to an information data set;

searching means for identifying information data sets in said information system relevant to said specified category of information to be accessed; and

selecting means arranged to trigger said calculating means to calculate values of said metric for information data sets identified by said searching means, to input the values so calculated to said information classifier to determine and output respective applicable levels of expertise selected from said plurality of predetermined levels of expertise, and to select, for access, information data sets from those identified by said searching means having respectively determined levels of expertise that match said specified level of expertise.

A apparatus according to the fifth aspect of the present invention may be supplied with a ready-trained information classifier rather than one that has yet to be trained. An information classifier already trained using a general cross-section of training information data sets has been found to provide an acceptable level of performance when used to access information data sets across a range of information categories.

Preferred embodiments of the present invention will now be described, by way of example only, with reference to the accompanying drawings of which:

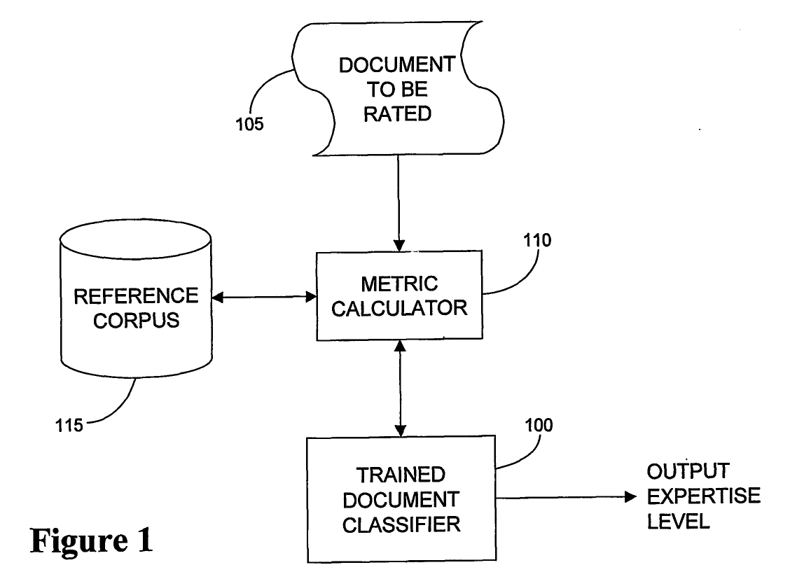

FIG. 1 is a diagram showing a trainable document classifier usable in an apparatus according to a first embodiment of the present invention;

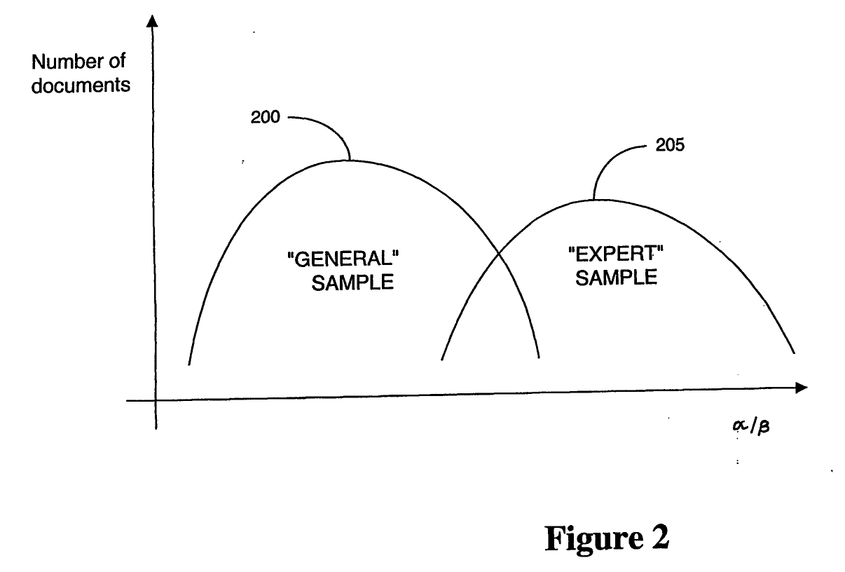

FIG. 2 is a diagram showing typical distributions of a preferred metric for a training sample of documents;

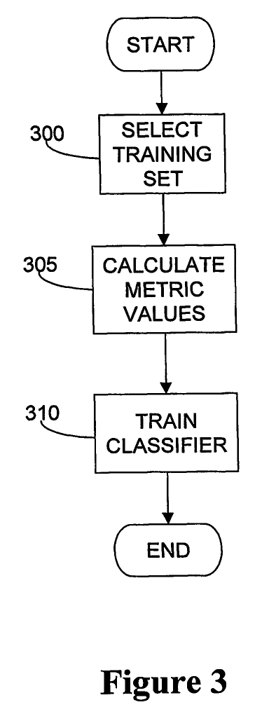

FIG. 3 is flow diagram showing steps in a preferred training process;

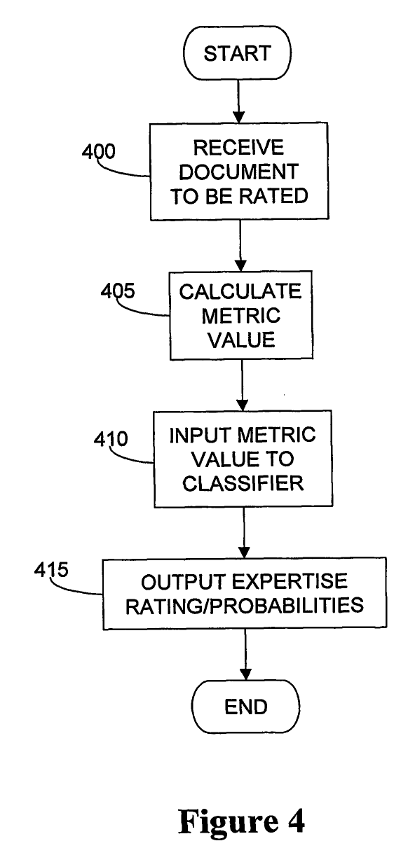

FIG. 4 is a flow diagram showing preferred steps in operation of the apparatus of FIG. 1; and

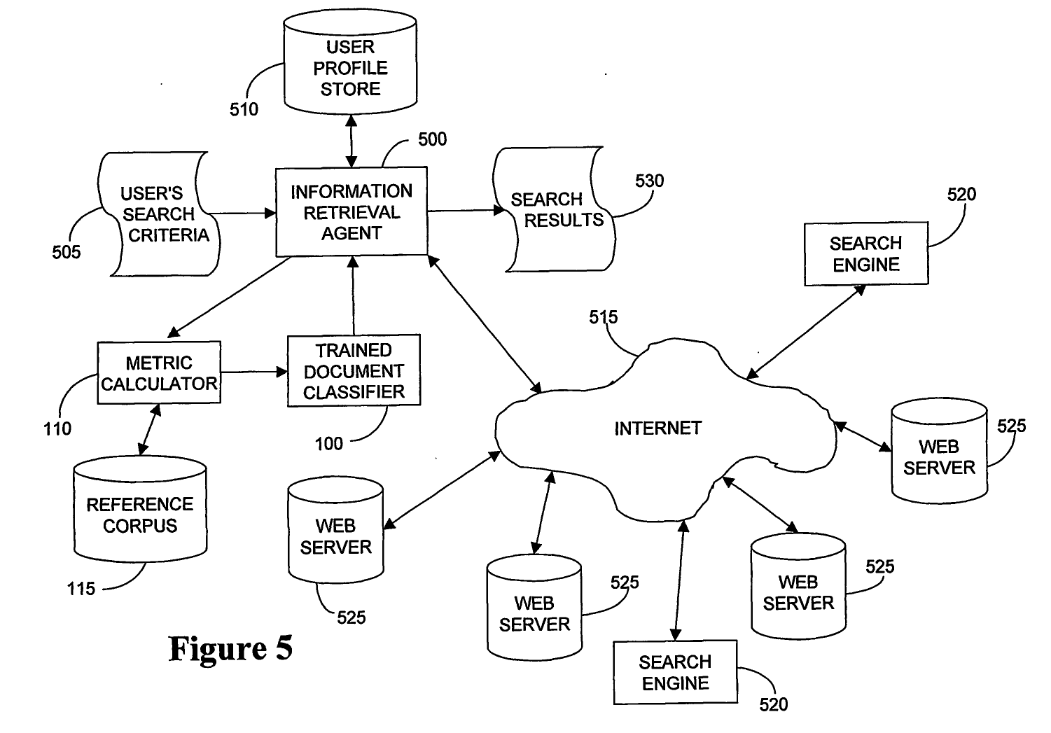

FIG. 5 is an information retrieval apparatus according to a second embodiment of the present invention.

This invention arises from the observation by the inventors in the present case that a metric comprising a statistical measure of the “commonality” of terms occurring in a document with reference to a corpus of information representative of the use of words in a particular language can be used to train a conventional document classifier to distinguish those documents intended for general readership from those directed to a more expert reader. In the English language in particular, this metric may be calculated preferably with reference to the British National Corpus—a 100,000,000 word electronic databank sampled from the whole range of present-day English, spoken and written. Word frequencies for the British National Corpus have been published for example in “Word Frequencies in Written and Spoken English: based on the British National Corpus.” by Geoffrey Leech, Paul Rayson and Andrew Wilson, published (2001) by Longman, London, ISBN 0582-32007-0 (Paperback).

A first embodiment of the present invention will now be described with reference to FIG. 1.

Referring to the diagram of FIG. 1, a trained document classifier 100 is shown that has been trained, by a process to be described below, to determine and to output a rating corresponding to one of a number of predefined levels of expertise to be associated with a given document 105, or to determine and to output a probability that the given document 105 relates to one or more of those predefined levels of expertise. A metric calculator 110 is arranged with access to a reference corpus 115 of information in a particular language to enable it to calculate, for the given document 105, the value of a metric, to be defined below, indicative of the “commonality” of terms occurring in the document 105. The classifier 100 has been trained to use a value of the metric calculated by the metric calculator 110 to determine the appropriate level of expertise to associate with the document 105. The expertise rating output by the trained classifier 100 may be used in a number of different applications, in particular in an improved information retrieval arrangement where only those documents that match a user's measure of expertise in a particular field of information are selected from a set of search results for presentation to the user.

A preferred metric found to be suitable for use with a document classifier 100 to determine an expertise rating for a given document 105 is derived as follows. A value a is first calculated, by the metric calculator 110, for the given document 105 using the formula

$$α = {\sum }_{i} log ( {tf}_{i} + 1 ) log ( \frac{N}{n ( i )} )$$

where tf₁ is the term frequency within the given document 105 of the i-th distinct (preferably stemmed using the algorithm referenced above) term of the given document 105,

n(i) is the number of documents in the reference corpus 115 containing the i-th distinct (stemmed) term of the given document 105 and

N is the total number of documents in the reference corpus 115.

Preferably the value of n(i)/N is available directly as output from an interface to the reference corpus 115 for any particular stemmed term. For example, for a particular stemmed term, the reference corpus 115 returns a value representing the frequency with which the particular stemmed term occurs per million terms in the corpus 115.

The preferred metric then calculated by the metric calculator 110 is a “normalised” value for α, obtained by dividing α by a value β, where β is defined by:

$$β = \frac{length\_of \_the \_given \_document}{mean\_length \_of \_documents \_in \_the \_reference \_corpus}$$

It has been found that when the values for this preferred metric α/β are plotted for a range of documents, those documents typically directed to “expert” readers in a particular field have a substantially distinct range of values for α/β in comparison with that for documents intended for more “general” readership. The differences in the two distributions can be seen, for a particular sample of documents, in FIG. 2.

Referring to FIG. 2, two distributions are shown, one distribution 200 for a sample of documents known to be intended for “general” readership and one distribution 205 for a sample of documents known to be intended for more “expert” readership. If more than two levels of expertise are to be distinguished, then samples of documents may be selected representative of one or more intermediate levels of expertise and the corresponding distributions plotted. Distributions may also be made in respect of samples of documents distinguishing “child” from “adult” levels of “expertise”.

There are numerous variations to the formulae provided above for calculating a and β of the preferred metric, for use in preferred embodiments of the present invention, that would be apparent to a person of ordinary skill, each variation taking account of the “commonality” of terms occurring within a given document. In addition, there are numerous variations in the way in which terms of a given document may be selected for use in calculating a value for the preferred metric. For example, rather than considering every term within a given document, a known algorithm may be used to select terms most likely to be indicative of the information content of the given document, for example an algorithm to extract so-called “key terms” as described in European patent number EP 1032896 by the present Applicants. In a further variation, the reference corpus 115 used in preferred embodiments of the present invention may be selected from a range of specialised corpi according to the particular information topic of documents under consideration or, more generally, according to whether the documents under consideration relate to technical or non-technical subject matter, or to children's literature for example.

Having determined a suitable metric as defined above, the next step is to use that metric to train a document classifier either to identify which of the predefined levels of expertise to associate with a given document 105, or to determine a set of probabilities that a given document 105 is associated with one or more of the predefined levels of expertise. To this end, steps in a preferred training process will now be described with reference the flow diagram of FIG. 3.

Referring to FIG. 3, the training process begins with, at STEP 300, selection of a training set of documents comprising, for each of the predetermined levels of expertise to be applied, a representative training sample of documents known to contain subject matter expressed in a way suitable for readers having that level of expertise, e.g. “expert” readers or those with only a “general” appreciation of a given information topic. In practice, while the training set of documents may relate to a particular information topic and a different training set of documents may be selected for each information topic, it has been found that a more general training set yields acceptable results when used to rate documents relating to a number of different information topics. At STEP 305, the value for the preferred metric α/β is calculated, for example by the metric calculator 110, for each of the documents in the training set. At STEP 310, knowing the level of expertise associated with each document of the training set and the corresponding values for α/β, a conventional document classifier is trained to associate a given document 105 with one of the predefined levels of expertise on the basis of a respective value for α/β. Preferably, the document classifier may be trained at STEP 310 by making distributions of document frequency in the respective training sample sets for values of α/β, as in FIG. 2, and on the basis of the document frequency distributions for each sample, determining the range of values of α/β corresponding to each of the pre-defined levels of expertise (there being two levels of expertise—“General” and “Expert”—in the example of FIG. 2). Alternatively, if required, the document classifier 100 may be arranged, after training, to output probability values in respect of each of the predefined levels of expertise yielding a non-zero probability for the given document 105.

Steps in a preferred process, operable by the apparatus of FIG. 1, for determining the level of expertise for a given document 105, will now be described with reference to the flow diagram of FIG. 4.

Referring to FIG. 4, the preferred process begins at STEP 400 with receipt of a document 105 to be rated. At step 405 the value of the preferred metric α/β is calculated by the metric calculator 110 for the received document 105 using the formulae provided above, with reference to the reference corpus 115. Preferably, when accessing the reference corpus 115 to obtain a relative frequency score for a stemmed form of a particular term, if the reference corpus 115 provides relative frequency scores for homonyms of the particular term, the metric calculator 110 is arranged to sum the relative frequencies provided for each homonym. That is, no attempt is made by the metric calculator 110 to distinguish use of a particular term in a given document 105 as a preposition from its use as an adjective, for example, before obtaining the relative frequency score from the reference corpus 115. However, the metric calculator 110 may be arranged optionally to implement a known algorithm to analyse terms in the given document 105 and to identify the particular use of each term before obtaining the respective score for that use of the term from the reference corpus 115.

The resultant value for α/β is input, at STEP 410, to the trained document classifier 100, preferably trained according to the process of FIG. 3, and at STEP 415 the trained document classifier 100 outputs either an indication of the level of expertise to associate with the received document 105 or a set of probabilities that the received document 105 is associated with each of one or more of the levels of expertise. This latter output is of particular use in fuzzy processing systems.

A preferred information retrieval apparatus will now be described with reference to FIG. 5, incorporating the trained document classifier 100 of FIG. 1 in a preferred embodiment of the present invention.

Referring to FIG. 5, an information retrieval software agent 500 is arranged to operate on behalf of a user to identify documents relevant to the users submitted search criteria 505. Search criteria 505 typically comprise a set of keywords/phrases relating to a particular category of information sought by the user. The information retrieval software agent 500 is arranged with access to a user profile store 510 wherein a predefined user profile may be stored for the user, the profile containing an indication of the level of expertise of the user in respect of the particular category of information being sought. However, the level of expertise of the user submitting the search criteria 505 may optionally be specified within the search criteria 505, so obviating the need for the information retrieval software agent 500 to make a separate access to the user profile store 510 to obtain the user's expertise level.

The information retrieval software agent 500 is arranged with access to the Internet 515 and hence to one or more search engines 520 to help identify and retrieve sets of information stored on web servers 525 relevant to the user's submitted search criteria 505. The information retrieval software agent 500 is also arranged with access to a trained document classifier 100 as above, by way of a metric calculator 110 arranged with access to a reference corpus 115 for calculating a value for the metric α/β, as defined above, for a particular document, which value when input to the trained document classifier 100 enables the level of expertise associated with the particular document to be determined. The information retrieval software agent 500 is arranged to output a list of search results 530 in response to the users submitted search criteria 505, the search results 530 being tailored both to the user's specified category of information (505) and to the user's level of expertise (510) with respect to that category of information (505).

In operation, the information retrieval software agent 500 is arranged, on receipt of search criteria 505 submitted by a user, to access the user's personal profile 510 to determine the level of expertise of the user in respect of the category of information represented by the submitted criteria 505, assuming that the user has not specified his/her level of expertise within the search criteria 505. The information retrieval software agent 500 then accesses search engines 520 or web servers 525 directly to identify and retrieve sets of information relevant to the information category specified in the submitted search criteria 505, by conventional means. As relevant information sets are identified and received, the information retrieval software agent 500 determines the level of expertise to be associated with each relevant information set using functionality provided by the metric calculator 110 and the trained document classifier 100, as described above with reference to FIG. 4. The information retrieval software agent 500 compares the level of expertise determined for each relevant information set with the level of expertise (510) of the user and thereby selects, to output to the user as search results 530, a set of relevant information sets having determined levels of expertise matching the user's level of expertise.

In a further embodiment of the present invention a trained document classifier 100 may be used to derive a measure of the level of expertise of a user in respect of a particular information topic. By monitoring information retrieval activity of a user in respect of the particular information topic, those documents that the user evidently finds useful, for example because the user retrieves a whole document to read or provides feedback as to the usefulness of the document, may be input to the metric calculator 110 and the respective metric values input to the trained document classifier 100 to determine the level of expertise to associate with these “useful” documents and hence, by implication, the level of expertise of the user in the information topic that those documents represent.

It would be apparent to a person of ordinary skill in this field of information retrieval, that preferred embodiments of the present invention may be applied in other information retrieval arrangements in which the expertise of a user may be taken into account when selecting information for presentation to that user or otherwise used in respect of that user.

1. A method for determining a measure of the level of expertise applicable to a given information data set, comprising the steps of:
(i) selecting, in respect of each of a plurality of predetermined levels of expertise, a representative sample set of information data sets;
(ii) determining, for each of said selected information data sets, the value of a metric indicative of the incidence, in a reference corpus of information, of terms comprised in the selected information data set; and
(iii) using the values of said metric determined in step (ii) to train an information classifier to identify, from a value of said metric calculated for the given information data set, at least one of said plurality of predetermined levels of expertise applicable to the given information data set.

2. A method as in claim 1, wherein said metric comprises a combined measure of the incidence within an information data set of terms comprised in the information data set and of the incidence of each said term in the reference corpus.

3. A method as in claim 1, wherein at step (iii), training the classifier comprises:
(a) making distributions of normalised values of said metric for data sets in each of the representative sample sets selected at step (i); and
(b) for each of said predetermined levels of expertise, identifying from said distributions a corresponding range of normalised values of said metric.

4. A method as in claim 1, wherein at step (iii), the trained classifier is arranged to determine a measure of the probability that a particular one of said predetermined levels of expertise is applicable to the information data set.

5. A method as in claim 1, wherein determining a value for said metric comprises applying a stemming algorithm to stem terms comprised in a respective information data set and determining the incidence of the stemmed terms in the reference corpus.

6. A method as in claim 1, wherein the reference corpus is provided with an interface for outputting the relative frequency of occurrence in the corpus of a term.

7. A method of accessing information data sets, stored in an information system, relevant to search criteria specifying an indication of a category of information to be accessed and to a specified indication of a predetermined level of expertise in respect of said category of information, the method comprising the steps of:
(i) selecting a training set of information data sets comprising, for each of a plurality of predetermined levels of expertise, a representative sample set of information data sets;
(ii) determining, for each data set in the training set, the value of a metric indicative of the incidence, in a reference corpus of information, of terms comprised in the training data set;
(iii) using the values of said metric determined in step (ii) to train an information classifier to identify at least one of said plurality of predetermined levels of expertise applicable to a given information data set;
(iv) applying an information searching algorithm to identify information data sets stored in said information system relevant to said specified category of information; and
(v) using the classifier trained at step (iii) to determine respective levels of expertise for information data sets identified at step (iv) and comparing the determined levels of expertise with the specified level of expertise to thereby select relevant information data sets.

8. An apparatus for determining a level of expertise applicable to an information data set, the level of expertise being selected from a plurality of predetermined levels of expertise, the apparatus comprising:
an input for receiving an information data set;
calculating means arranged with access to a reference corpus of information to calculate, for an information data set, the value of a metric indicative of the incidence, in the reference corpus, of terms comprised in the information data set;
a trainable classifier; and
training means for training said classifier to identify, using a training set of information data sets comprising, for each of said plurality of predetermined levels of expertise, a representative sample set of information data sets and respective values of said metric, an applicable level of expertise selected from said plurality of predetermined levels of expertise for a received information data set;
wherein, in operation, on receipt of an information data set at said input, said calculating means are arranged to calculate a respective value for said metric and to input the calculated value to said trainable classifier, trained by said training means, to determine and output an indication of at least one of said plurality of predetermined levels of expertise applicable to said received information data set.

9. An apparatus as in claim 8, wherein said metric comprises a combined measure of the incidence within an information data set of terms comprised in the information data set and of the incidence of each said term in the reference corpus.

10. An apparatus as in claim 8, wherein said training means are arranged to train said trainable classifier using the steps of:
(a) making distributions of normalised values of said metric for data sets in each of the representative sample sets; and
(b) for each of said predetermined levels of expertise, identifying from said distributions a corresponding range of normalised values of said metric.

11. An apparatus as in claim 8, wherein said trainable classifier is arranged, after training by said training means, to determine a measure of the probability that a particular one of said plurality of predetermined levels of expertise is applicable to a received information data set.

12. An apparatus as in claim 8, wherein said calculating means are arranged to calculate a value for said metric by applying a stemming algorithm to stem terms of a respective information data set and by determining the relative incidence of the stemmed terms in the reference corpus.

13. An information retrieval apparatus for accessing information data sets, stored in an information system, relevant to received search criteria specifying an indication of a category of information to be accessed and to a specified indication of a predetermined level of expertise in respect of said category of information, the apparatus comprising:
calculating means arranged with access to a reference corpus of information to calculate, for an information data set, the value of a metric indicative of the incidence, in the reference corpus, of terms comprised in the information data set;
a trainable classifier;
training means for training said classifier to identify, using a training set of information data sets comprising, for each of a plurality of predetermined levels of expertise, a representative sample set of information data sets and respective values of said metric, an applicable level of expertise selected from said plurality of predetermined levels of expertise for a given information data set;
searching means for identifying information data sets in said information system relevant to said specified category of information to be accessed; and
selecting means arranged to trigger said calculating means to calculate values of said metric for information data sets identified by said searching means, to input the values so calculated to said trainable classifier, trained by said training means, to determine and output respective applicable levels of expertise selected from said plurality of predetermined levels of expertise, and to select, for access, information data sets from those identified by said searching means having respectively determined levels of expertise that match said specified level of expertise.

14. An information retrieval apparatus for accessing information data sets, stored in an information system, relevant to received search criteria specifying an indication of a category of information to be accessed and to a specified indication of a predetermined level of expertise in respect of said category of information, the apparatus comprising:
calculating means arranged with access to a reference corpus of information to calculate, for an information data set, the value of a metric indicative of the incidence, in the reference corpus, of terms comprised in the information data set;
an information classifier, trained, using, for each of a plurality of predetermined levels of expertise, a representative sample set of training information data sets and respective values of said metric, to determine a level of expertise, selected from said plurality of predetermined levels of expertise, applicable to an information data set;
searching means for identifying information data sets in said information system relevant to said specified category of information to be accessed; and
selecting means arranged to trigger said calculating means to calculate values of said metric for information data sets identified by said searching means, to input the values so calculated to said information classifier to determine and output respective applicable levels of expertise selected from said plurality of predetermined levels of expertise, and to select, for access, information data sets from those identified by said searching means having respectively determined levels of expertise that match said specified level of expertise.
